(19) United States
(12) Patent Application Publication
(10) Pub. No.: US 2008/0142568 A1
(43) Pub. Date: Jun. 19, 2008

(54) CIRCUIT CARRIER BOARD/SOLDER PALLETT

(75) Inventor: Richard A. Reed, Strongsville, OH (US)

Correspondence Address: PEARNE & GORDON LLP, 1801 EAST 9TH STREET, SUITE 1200, CLEVELAND, OH, 44114-3108, US

(73) Assignee: Electrolock, Inc., Hiram, OH (US)

(21) Appl. No.: 11/948,418

(22) Filed: Nov. 30, 2007

Related U.S. Application Data
(63) Continuation-in-part of application No. 11/400,866, filed on Apr. 10, 2006, now abandoned.
(60) Provisional application No. 60/711,232, filed on Aug. 25, 2005.
(60) Provisional application No. 60/670,537, filed on Apr. 11, 2005.

(51) Int. Cl. B23K 3/08; B29C 67/24

(52) U.S. Cl. 228/44.7; 228/47.1; 264/319; 264/330

(57) ABSTRACT

Provided is a plaque and its method of manufacture, the plaque including a binding material and a reinforcing material that is molded into a controlled thickness. Also provided is a solder pallet utilizing the plaque in its manufacture. The plaque can be manufactured by forming a preform of the raw materials, optionally preheating the preform, molding the preform into a plaque of the desired thickness, and then cooling the plaque at an elevated temperature to maintain the flatness of the plaque without the need for sanding or otherwise machining the plaque to the desired size. The plaque can then be formed into the desired solder pallet by cutting the plaque to appropriate dimensions, if necessary, and adding holes and/or clips for use in a soldering process for soldering circuit boards, for example.

### CROSS-REFERENCES TO RELATED APPLICATIONS

This application is a continuation-in-part of application Ser. No. 11/400,866, filed on Apr. 10, 2006, which claims the benefit of provisional application No. 60/670,537 filed on Apr. 11, 2005, and provisional application No. 60/711,232, filed on Aug. 25, 2005, all incorporated herein by reference.

### BACKGROUND OF THE INVENTION

This application relates to a circuit board carrier and/or a solder pallet for use in a soldering machine, and to its method of manufacture.

A solder pallet having one or more improved properties, such as higher temperature performance (such as around 270 degrees C. Tg or above vs. current solutions of only about 170˜190 degrees C.), ease of machining, long-term wear, and durability under a combination of high temperature exposure and aggressive chemicals would be useful. In addition, it would be useful to avoid glass exposure due to wear, which can be a problem with at least some current materials.

Furthermore, a plaque used for producing a solder pallet with the above properties would also be useful, especially if the plaque could be manufactured to meet thickness requirements of the solder pallet manufacturer or customer, and if the plaque, and thus the resulting solder pallet, could utilize modern for additional beneficial properties. Furthermore, a solder pallet that can be used with modern low lead or lead free solders, especially those utilizing a halide flux system without degradation would be beneficial.

In addition, brittleness and a lack of strength in some formulations of solder pallets can make machining difficult, and thus utilizing materials that reduce such brittleness and increase strength would be useful. Furthermore, machining, such as sanding or grinding, of some pallet materials may lead to minute uneven surfaces and/or voids and/or exposure of the reinforcing fibers that then degrade during use due to materials (such as fluxes, for example) that may contain acids or other corrosive materials, and thus materials that don't require such machining or that avoid such voids after machining would also be useful.

### SUMMARY OF THE INVENTION

Provided are a plurality of embodiments the invention, including, but not limited to, a flat plaque for use in a soldering process, the plaque comprising: a thermoset phenolic resin; and a re-enforcing fiber distributed throughout the plaque, wherein the composition has been formed into the flat plaque at a desired thickness.

Further provided is a plaque for use in making a solder pallet, the plaque comprising: a thermoset phenolic resin; a glass re-enforcing fiber distributed throughout the plaque; and a conducting or semi-conducting material distributed throughout the plaque, wherein the plaque has a glass transition temperature of more than 170 degrees Celsius; and wherein the plaque is at least semi-conducting for discharging static electricity that may be present during use of the solder pallet.

Also provided is a solder pallet, such as described herein, using one of the above plaques or a plaque described elsewhere herein, with the pallet further comprising one or more clips for holding a circuit board to the pallet, and/or including one or more holes so that molten solder can access the circuit board or a component thereon.

And provided a plaque for use in making a solder pallet where the plaque comprises a thermoset phenolic resin; a glass re-enforcing fiber distributed throughout the plaque; substantially spherical reinforcing particles having a plurality of layers with the reinforcing particles being distributed throughout the plaque; and a conducting or semi-conducting material distributed throughout the plaque. The plaque is provided to have a glass transition temperature of more than 190 degrees Celsius; and the plaque is provided to be at least semi-conducting for discharging static electricity that may be present during use of the solder pallet.

Furthermore, the above plaque can be provided where the reinforcing particles comprise phenolic-coated butyl rubber nano-particles that may be substantially spherical and could have a diameter of about 100 nm.

Further provided is a method of manufacturing a plaque, such as one of those described herein, for use in a soldering process, the method comprising the steps of: providing a composition including a thermoset phenolic resin and a plurality of re-enforcing fibers; and forming the plaque in a mold by providing heat and pressure to the composition to form a solid plaque of a desired thickness.

Also provided is a method of manufacturing a plaque, such as one described herein, the plaque for use in a soldering process, the method comprising the steps of:
providing a precursor composition including the steps of:
providing a thermoset phenolic resin,
providing re-enforcing fibers, and
forming the resin and fibers into the precursor composition;
forming a preform by putting a portion of the precursor composition under pressure to form the preform;
pre-heating the preform;
molding the pre-heated preform in a mold by providing heat and pressure to the preform to form a molded plaque; and
maintaining a flatness of the plaque by cooling the molded plaque against smooth surfaces at an elevated temperature, thereby forming the plaque.

Still further provided is a method of manufacturing a solder pallet, such as one described herein, by one of the methods described above or elsewhere herein, with the method including the steps of providing one or more clips for holding a circuit board to the pallet, and/or providing one or more holes so that molten solder can access the circuit board or a component thereon.

Also provided is a flat plaque for use in a soldering process, with the plaque comprising: a binding material; and a re-enforcing fiber distributed throughout the plaque, wherein the composition has been formed into the flat plaque at a desired thickness without sanding or grinding.

Further provided is a solder pallet for use in a soldering process, with the solder pallet comprising: at least a portion of a plaque as described in this application and means for holding a circuit board on the solder pallet as discussed herein.

In addition is provided a plaque for use in making a solder pallet, the plaque comprising: a binding material including a vinyl ester; a glass re-enforcing fiber distributed throughout the plaque; and a conducting or semi-conducting material distributed throughout the plaque, wherein the plaque has a glass transition temperature of more than 190 degrees Celsius; and wherein the plaque is at least semi-conducting for discharging static electricity that may be present during use of the solder pallet.

Further provided is a solder pallet comprising at least a portion of a plaque as described herein having at least one hole formed therethrough, and means for holding a circuit board on the solder pallet, wherein the at least one hole is adapted for providing contact between the circuit board or a component mounted on the circuit board and molten solder.

Further provided is solder pallet including: a plaque for use in making a solder pallet, the plaque comprising: a binding material including a vinyl ester; a glass re-enforcing fiber distributed throughout the plaque and bound together by the binding material also distributed throughout the plaque; and a conducting or semi-conducting material distributed throughout the plaque, wherein the plaque has a glass transition temperature of more than 190 degrees Celsius; and wherein the plaque is at least semi-conducting for discharging static electricity that may be present during use of the solder pallet. The solder pallet also comprising a plurality of holding devices and/or holes adapted for holding a circuit board in place.

Also provided is a method of manufacturing a plaque for use in a soldering process, the method comprising the steps of:
providing a composition including a binding material and a plurality of re-enforcing fibers;
molding the plaque in a mold by providing one or both of heat and pressure to the composition to form a solid plaque of a desired thickness, wherein
the binding material is distributed throughout the composition prior to the molding step.

Further provided is a method of manufacturing a plaque for use in a soldering process, the method comprising the steps of:
providing a precursor composition including the steps of: providing a vinyl ester, providing re-enforcing fibers, and forming the vinyl ester and re-enforcing fibers into the precursor composition into a monolithic uniform product;
forming one or more preforms by putting a portion of the precursor composition under pressure to form the preforms;
molding the one or more preforms in a mold by providing one or both of heat and pressure to the one or more preforms to form a molded plaque; and
maintaining a flatness of the plaque by cooling the molded plaque against smooth surfaces at an elevated temperature, thereby forming the plaque.

Also provided are additional embodiments of the invention, some, but not all of which, may be described hereinbelow in more detail.

### BRIEF DESCRIPTION OF THE DRAWINGS

The foregoing and other features and advantages of the present invention will become apparent to those skilled in the art to which the present invention relates upon reading the following description, with reference to the accompanying drawings, in which:

FIG. 1 shows a drawing of the front side of one example embodiment of a solder pallet;

FIG. 2 shows a drawing of the front side of another example embodiment a solder pallet;

FIG. 3 shows a drawing of the back side of the example embodiment of FIG. 1;

FIG. 4 shows a drawing of the back side of the example embodiment of FIG. 2;

FIG. 5 shows the front side of still another example embodiment of a solder pallet that is holding a circuit board for undergoing a soldering process;

FIG. 6 shows the back side of the example embodiment of FIG. 5 shown holding the circuit board before undergoing a soldering process;

FIG. 7 shows a heating device for pre-heating example preforms for forming an example embodiment of a plaque used to create a soldering pallet;

FIG. 8 shows an example of a mold for forming an example plaque from one or more preforms, such as the example preforms shown in FIG. 7;

FIG. 9 shows an example of a flattening device for keeping a plaque flat during cooling at elevated temperatures after molding;

FIG. 10 is a flow chart showing an example manufacturing process that can be used for manufacturing a precursor, then a plaque and then a soldering pallet, such as those described herein; and

FIG. 11 is a flow chart showing another example manufacturing process that can be used for manufacturing a precursor of a different composition, then a plaque and then a soldering pallet, such as those described herein.

### DETAILED DESCRIPTION OF THE EXAMPLE EMBODIMENTS

Provided is a plaque for producing a solder pallet for use, for example, in soldering machines, such as for wave soldering, and a method of manufacturing the plaque. Also provided is a solder pallet produced from the plaque, and a precursor composition and a resulting preform used in manufacturing the plaque.

The outstanding characteristic of cured thermoset phenolic molding material can provide excellent thermal performance. Thermal performance refers to the ability of a molded plastic product to maintain its structural integrity, under mechanical load during a prolonged exposure to elevated temperatures. The thermal performance of polymer systems is closely related to their glass transition temperature (Tg). This is the temperature at which the molecules rapidly gain in their mobility as the cured molded sample is heated. Even in the presence of fillers and reinforcements that provide the apparent initial rigidity, exposure to temperatures above the Tg will usually cause a polymer to flow or creep under load. Thus, in at least some embodiments, a cured thermoset phenolic molding material is utilized to provide improved thermal performance.

The relatively high glass transition temperature of cross-linked polymers, such as phenolic resins, can result in excellent resistance to creep under mechanical load. A useful property of a cured phenolic material is the ability to raise its Tg by a carefully controlled post bake protocol, such as heating the part to 200 degrees C. and/or repressed in a device under pressure and temperature of 200 degrees C., after the part is molded. When correctly applied, the post bake program can result in a further improvement in creep resistance, dimensional stability, and modulus (stiffness) at elevated temperature. Thus, utilizing such cross-lined polymers can lead to a solder pallet that shows improved creep resistance.

Because of possible excellent thermal performance, phenolic molding materials are specified to insulate and protect sensitive components from the adverse effect of high temperature exposure. The solder pallet according to at least some embodiments can be formulated with resole or novolac resin systems, and specially selected fillers and reinforcements, in order to meet end use specifications. Consumer safety can be enhanced when the potential for the end product to overheat, melt or initiate a fire is minimized through the selective use of a heat resistant phenolic molding material.

Phenolic molding material can be formulated to provide tight dimensions with minimal deformation under mechanical load at elevated temperatures. This characteristic is useful when considering calibration requirements, screw-torque retention, and dimensional specifications to prevent thermal, mechanical, or electrical failure, especially during thermal cycling of end used products. Thus, this material can be usefully utilized in each of the precursor, the preform, the plaque, and the solder pallet, all described herein in more detail.

This unique phenolic molding material can also be enhanced with graphite, PTFE, and other internal lubricants. This formulation provides excellent lubricity and abrasion resistance for components that require repeated mechanical cycling or part-to-part contact, such as solder pallets. A key advantage of components molded from these materials is their ability to maintain surface smoothness after mechanical lapping. Thus, a plaque and a resulting solder pallet that uses such material can show similar benefits.

Alternative molding materials, disclosed hereinbelow, utilize Vinyl Ester materials in place of the phenolic molding material, with improved properties.

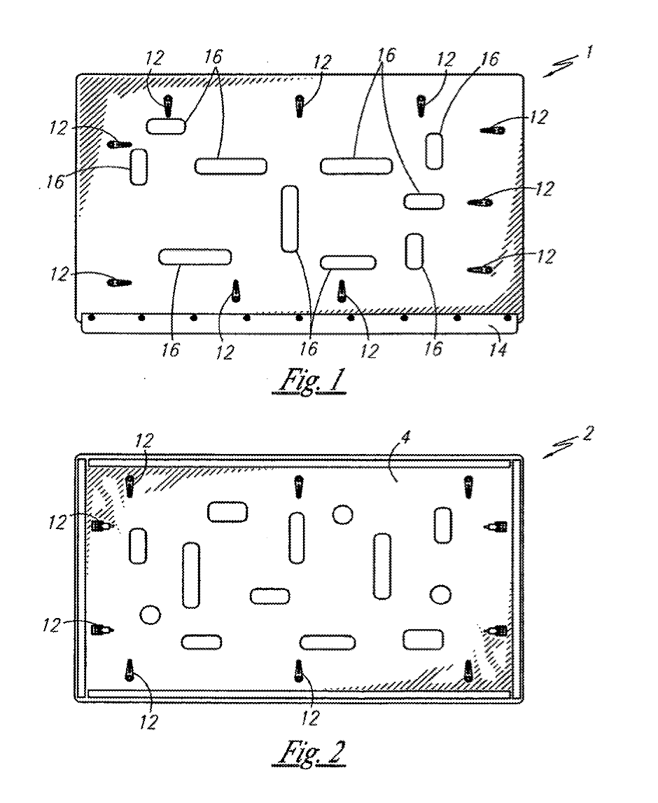

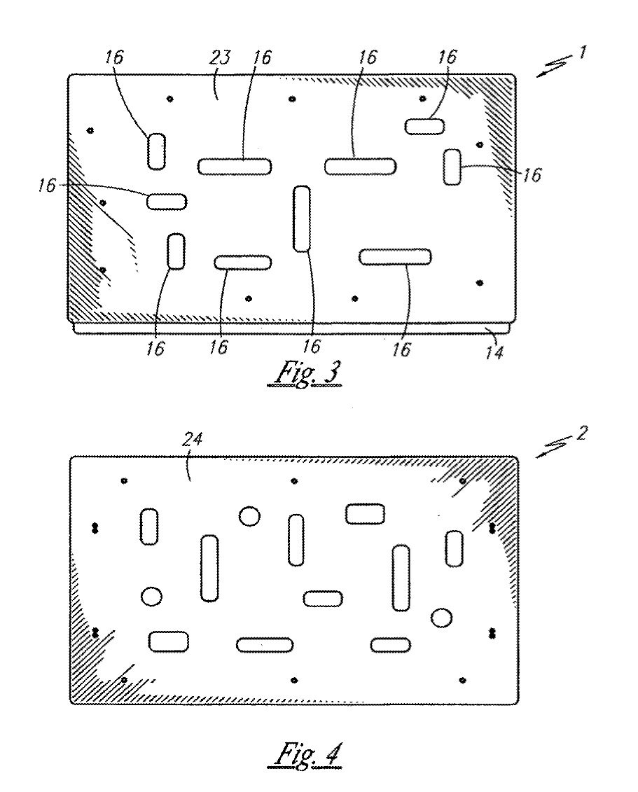

FIGS. 1 and 2 show front sides 3, 4 of example embodiments of solder pallets, made from a plague using one of the compositions discussed herein. These solder pallets 1, 2 use various types of holding devices for holding a circuit board in place. The holding device can include, for example, clips 12 to be used for holding circuit boards in place. Other equivalent devices can be used to hold the circuit board in place. FIG. 1 shows a metal strip 14 for use as a stiffener to maintain dimensional stability under extreme temperature changes. The solder pallets 1, 2 have holes 16 (numbered only for the first embodiment for clarity), which will be discussed in more detail later. FIGS. 3 and 4 show back sides 5, 6 of the respective solder pallets 1, 2.

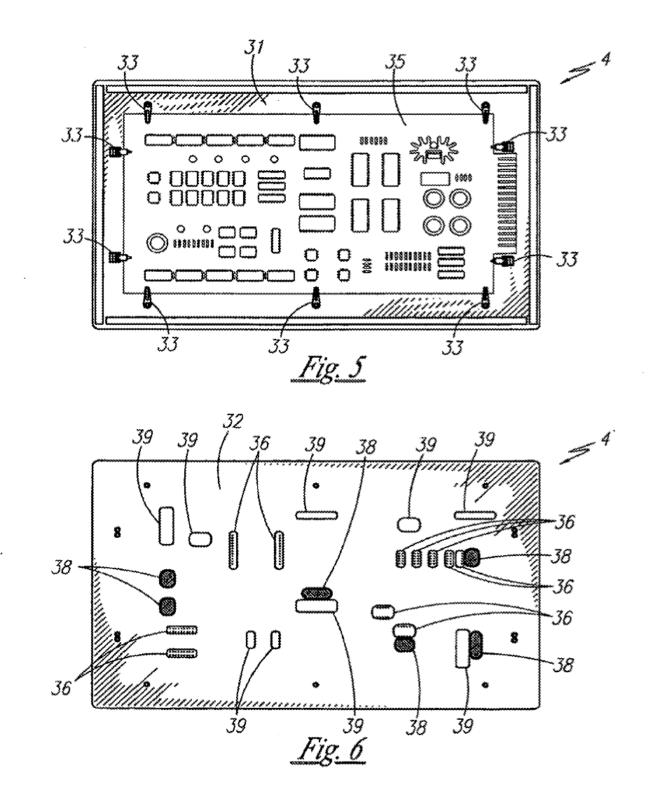

FIGS. 5 and 6 show the front side 31 and the back side 32 of still another example solder pallet 4, with a circuit board 25 mounted on the front side 31 using pins 33 to hold the board in place. Note that the holes 36 are provided for exposing the leads (pins) of various circuit board components (chips or other discrete components) through the holes 36 at the back of the pallet 4 to access a solder bath or stream for soldering the leads (pins) to appropriate circuit board etchings (not shown) on the circuit board 35. These boards can be used for wave soldering or other soldering processes, for example. Also shown are machined portions 38 that can be used for machine process flow and do not receive solder. These machined portions can be designed with a gradual radius to avoid 90 degree cuts for process ease. Additional holes 39 can be provided for additional components or etchings to access the solder during soldering, as desired.

Example Raw Materials

The raw material used for at least some of the embodiments of the plaque and the resulting solder pallet include a polymer, such as a phenolic resin matrix, of which Novalac Phenol Formaldehyde is an example. This polymer material can be reinforced with a reinforcing material, such as a chopped strand fiberglass, for example, along with graphite, for example, and potentially with other “metallo-silicates” as optional materials, as desired.

Using the phenolic resin polymer described above in the manufacturing process can provide a raw material that is a “single-stage” phenolic molding compound that does not yield any ammonia smell when exposed to high temperatures, such as use in a soldering process, for example. Using the unique blend of phenolic resin polymer with the chopped glass, by adding graphite or some other conductor or semiconductor, can yield a product that is at least electrically semi-conductive, and thus that can be utilized to bleed off static discharge that may be present in the soldering process for which the plaque or solder pallet may be used. Such a polymer formulation as described herein can also yield a material with a glass transition temperature of about 270 degrees Celsius, and which can have the technical properties listed in the technical data sheet provided below.

Modifications of the above composition can be provided to reduce brittleness and to increase the strength of the resulting solder pallet, thereby improving machineability, allowing the pallet to be machined into thin cross-sections. This can be done by adding reinforcing particles into the resin to increase the strength of the final product, by providing a means of dissipating energy, acting as a crack terminator, and relieving stress during curing.

For example, reinforcing particles comprising phenolic-coated butyl rubber nano-particles can be utilized with the phenolic resin compounds. Such nano-particles could include those of a substantially spherical shape having a size of about 100 nm in diameter, but which may vary in diameter. These then become homogenously disbursed throughout the epoxy resin, but can appear transparent in the cured product.

An example is Core Shell Rubber (CSR), marketed by Kaneka Corporation in Houston, Tex., which can be utilized as a strength enhancer. A 2-layer CSR provides a core of impact resistant polymer coated with a second polymer that is compatible with thermosetting resin. This is typically utilized at a ratio of about 25% by weight in the resin, and thus can substantially reduce the total amount of resin being utilized.

As an alternative, a vinyl ester structural molding compound can be utilized with reinforcing fibers using the disclosed process to yield a plaque or sheet with even better dimensional stability, better resistance to elevated temperatures, and sufficient electrical conductivity built into and throughout the material to dissipate electrostatic charge that is. This molding compound and resulting molded sheet offers excellent chemical resistance, hi strength to weight ratio, low heat absorption, and high strength at both room temperature and elevated temperatures. The material provides for a “zero shrink” to minimize warp while cooling, and reduces the brittleness that may be present in phenolic resin implementations. This material can also be molded at low temperatures ranging from 200 degrees F. to 250 degrees F. The benefits are include that all of these properties enable the resulting solder pallets to be used in a variety of continuous wave solder processes.

A preferred material for this alternative embodiment is, for example, a Sheet Molding Compound (SMC) made with chopped strand fiberglass (˜55%) by weight, Vinyl ester resin (˜30%) by weight, di-vinyl benzene (˜5%) by weight, conductive carbon black and various other additives. This SMC is in a state that is “homogeneous” pre-mixed state, and is a one part compound or system, versus the typical materials which involve pouring a liquid resin over layers of continuous strand fiberglass and forcing the resign to distribute evenly using pressure and/or heat. The result can be a sheet-molded compound that can be the consistency of a fibrous putty that can be molded to the desired thickness, typically without the necessity of sanding or machining to obtain the desired thickness.

Example Manufacturing Process

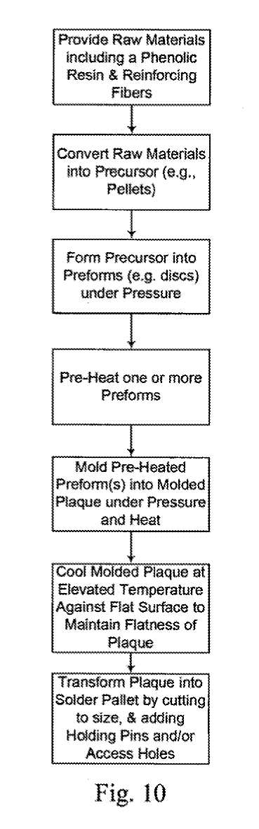

An example process that can be used as a manufacturing method to produce at least some embodiments of the plaques for forming solder pallets is now described, and one embodiment is shown in the flow chart of FIG. 10. This process can use a hybrid compression/injection molding process used for thermoset phenolic polymers. One example process is as follows:

The raw materials, including a phenolic resin that may be in powder or granular form, along with additional materials such as those described above (such as reinforcing fibers, reinforcing particles, etc.), are put into composition by mixing the materials together. The materials can be formed into a precursor composition designed for ease of transport and handling, for example, transformed into a pelletized or granular form. This precursor can be manufactured and provided by a third-party manufacturer, for example. Accordingly, the precursor typically includes the phenolic resin and one or more of: a reinforcing fiber such as fiberglass, a conducting or semiconducting material such as carbon (or other “metallo-silicates”), and a lubricant such as the carbon in the form of graphite, or PTFE. Additional materials could be included in the precursor for obtaining specific properties, such as special colors, etc. This precursor could be formed from the raw materials using pressure and/or heat, as needed.

The precursor can then be formed into a plurality of preforms by putting the pellets, or other precursor material, under pressure at room temperature to form the desired shape. For example, a cylinder can be formed that can be cut into a plurality of “puck-shaped” or rectangular prisms can be formed into “biscuit-shaped” preforms, or the preforms can be individually formed. Different shapes can also be formed, as desired, such as angular shapes, for example. Heat could be provided during forming the preforms, if desired, or they could be formed at room temperature, as described above. These preforms are thus derived from granular raw materials that are compressed into shape, in order to make it easier to handle and transfer the material from an Infrared preheating apparatus to an actual heated mold (described below). The preforms thus share the same composition as the precursors.

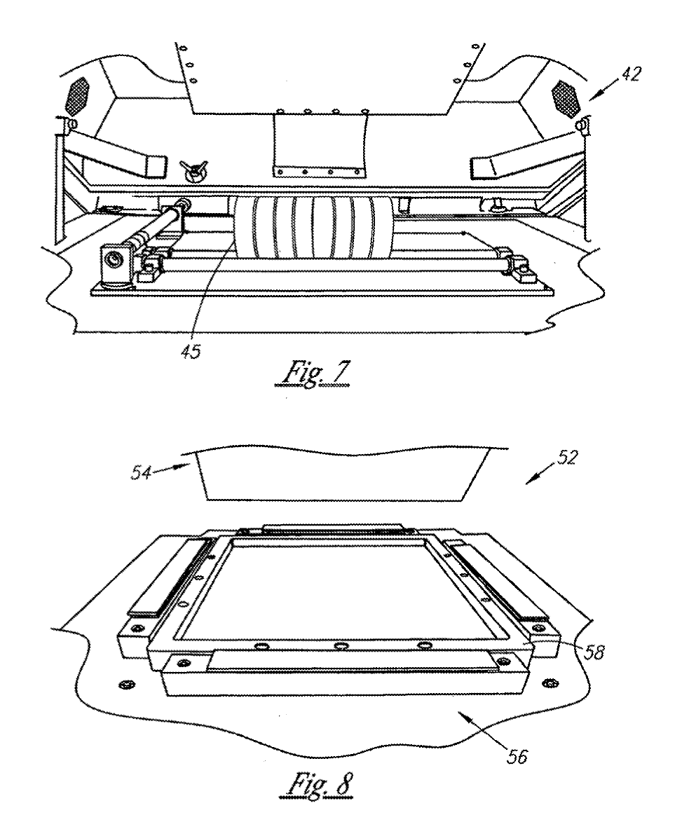

These preforms can then be pre-heated to aid in processing. In particular, embodiments using the phenolic resin molding compound may benefit from preheating, whereas embodiments using the vinyl ester compounds likely will not. Pre-heating the phenolic molding compound tends to ease the molding and help obtain the desired flatness of the product FIG. 7 shows an infrared preheating device 42 with a plurality of disc-shaped preforms 45 being pre-heated using infrared heating, although other methods of pre-heating the preforms could also be utilized. The preform is heated for some time period, such as for a 30 second cycle, to reduce cycle time in the mold. Alternatively, the pre-heating step may be skipped, if desired, and all heating done during the molding process. As suggested above, in some cases, in particular when using vinyl ester compositions in place of the phenolic compositions, preheating the performs, as outlined in step 4 of FIG. 10, can be avoided.

The end result and goal of this extensive process is to produce a finished plaque that has a molded thickness tolerance of +/−0.002″ and a warp tolerance of 0.030″ maximum total indicator reading. The resulting benefit to the customer is a pallet material that can be precisely machined the way it is without sanding flat.

One or more of the pre-heated preforms (about 10 or so of the size shown in FIG. 7 for the mold shown herein) can then be placed in the mold 52, shown in FIG. 8. The mold is then closed with about 3000 pounds per square inch of pressure used to compress the material to the desired thickness, while also heating the mold at about 325-350° F. Alternative molding processes using different pressures and/or different temperatures could also be utilized, especially depending on the chosen raw materials.

The mold is opened, the top and bottom cores 54, 56 are moved apart, while the cavity wall 58, shaped like a picture frame, retracts downward, exposing the molded plaque sitting on the bottom core 56. This process can be used to mold the product into a plaque to a desired thickness and flatness specification, and eliminate the need for knock out pins and thus avoid any corresponding marks on the surface of the plaque.

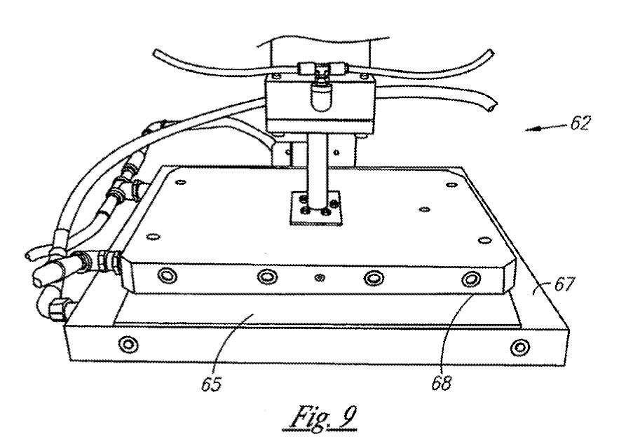

Next, the plaque can be quickly transferred to a temperature regulated flatness device 62, shown in FIG. 9 with a plaque 65 thereon, to control flatness and/or warp after the plaque is molded. The transfer could be done manually, for example, using protective gloves. The plaque is “cooled” on the flatness device against flat surfaces 66 and 67 at elevated temperatures (about 250 degrees F., for example) for some period of time, for example for about 5 minutes, to maintain flatness of the plaque. The plaque can then be removed from the device 62 to cool at room temperature, for example. This device 62 can provide some limited pressure to the cooling plaque, such as the pressure that comes from the dead load of a steel plate used as an upper flat surface 66, for example (at about 1 psi). Additional pressure could be provided if desired, or no pressure at all. The use of the flatness device ensures that the plaque remains substantially flat (avoiding warping), and thus helps to avoid any need to sand down the plaque to meet flatness and thickness requirements of customers. The device can also help keep the plaque surface at a desired smoothness.

Finally, solder pallets can be formed from the cooled plaque by machining (such as cutting) each plaque into a plurality of pieces to make solder pallets. The solder pallets might range in size roughly from 8″×10″ to 18″×24″, for example. The pallets are further formed by adding clips to the machined plaque pieces (such as by screwing or riveting them in place, for example) for mounting circuit boards thereon. The pins should probably be rotatable or otherwise movable to make mounting and dismounting the circuit boards easier. Furthermore, the plaque pieces can be further processed into the desired solder pallet configuration by machining holes in the plaque to match the pattern of the circuit boards mounted thereon, so that the molten solder of a solder bath or wave soldering machine can come into contact with the appropriate portion of the circuit board, for example. One or more stiffeners to maintain dimensional stability under extreme temperature changes can also be added. Machined portions that are for machine process flow and do not receive solder can also be added.

Utilizing reinforcing particles as described above can increase the strength of the resulting pallet, which can, as a result be machined to a very thin thickness of about 0.030 inches, if desired, such as for use as a circuit board carrier in certain applications. This improvement occurs because the reinforcing particles “cavitate” on impact, dissipating energy (such as by causing crack termination), thereby increasing the toughness and impact resistance of the resulting product, allowing thinner machining but also providing a satisfactory resulting strength.

Various variations of this manufacturing process can also be used, such as leaving out the preform-forming steps and using the pellets directly, or leaving out the flattening/cooling step and letting the device cool in the mold, or elsewhere, for example. Additional variations are also possible, and within the scope of this disclosure.

A process utilizing the phenolic resin molding compound, as described above, can be used to form a plaque or solder pallet with the following properties:

Technical Data Sheet-Phenolic Resin

| | | ASTM |
|---|---|---|
| Property | Value | Test Method |
| Color | Black | |
| ESD | 10\hat{ }5-10\hat{ }9 | D 4496 |
| Machinability | Excellent | |
| Chemical Resistance | Excellent | |
| Heat Deflection Temperature | ≧550° F. | D 648 |
| Water Absorption | .14 max | D 570 |
| Specific Gravity | 1.70 | D 792 |
| Flexural Strength, PSI | 25,000 | D 790 |
| Compressive Strength, PSI | 29,000 | D 695 |
| Warp | +/−.015″ | TIR over |
| | | entire sheet |
| Thickness Tolerance | +/−.005″ | Over the |
| | | entire sheet |
| Thickness, mm | e.g., 5, 6, 8, 10, 12 | |
| Sheet Size | 25″ × 25″ × | |
| | various thicknesses | |
| | (e.g., 3 mm to 12 mm | |

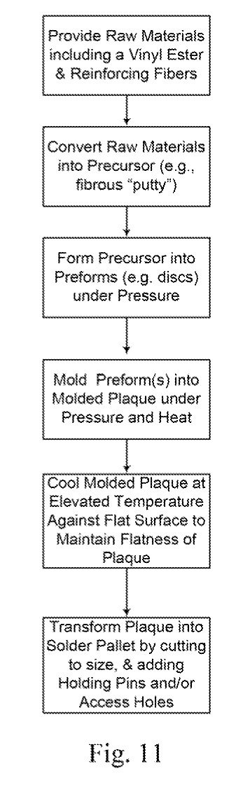

Alternatively, a similar process could be utilized for the vinyl ester structural molding compound, although when utilizing this compound, although preheating is typically not necessary, as discussed above. Such a process is shown in the flow chart of FIG. 11, and could utilize the equipment of FIGS. 7-9 described above. Furthermore, the use of reinforcing particles and/or metallo-silicates is typically not utilized. A process utilizing the vinyl ester molding compound can be used to form a plaque or solder pallet with the following properties:

Technical Data Sheet-Vinyl Ester

| | | ASTM |
|---|---|---|
| Property | Value | Test Method |
| Color | Granite Gray | |
| ESD | 10\hat{ }8-10\hat{ }11 | D 4496 |
| Machinability | Excellent | |
| Chemical Resistance | Excellent | |
| Heat Deflection Temperature | ≧375° F. | D 648 |
| Operating Temperature | >500° F. | |
| Water Absorption | .20 max | D 570 |
| Specific Gravity | 1.72 | D 792 |
| Flexural Strength, PSI | 55,000 | D 790 |
| Warp | +/−.015″ | TIR over |
| | | entire sheet |
| Thickness Tolerance | +/−.005″ | Over the |
| | | entire sheet |
| Thickness, mm | e.g., 5, 6, 8, 10, 12 | |
| Sheet Size | 25″ × 25″ × | |
| | various thicknesses | |
| | (e.g., 3 mm to 12 mm | |

Example Uses

As described herein, the raw materials are transformed, via a manufacturing process such as the example processes described above, from granular or other discrete forms into the desired rigid solid plaque of the desired thickness, which can then be made into a solder pallet for use in a soldering process. As far as raw material production goes, the phenolic resin embodiments can be manufactured in a reactor (via a reaction of phenol & formaldehyde), and the chopped glass fiber (and/or other reinforcements which may include mineral fibers and cellulose) can then be added along with mineral fillers (if any), the graphite, titanium dioxide, and internal lubricants (such as zinc stearate and/or other stearate compounds, for example), to form the preform to aid in the molding process.

The vinyl ester embodiments, in contrast, could be provided in a “homogeneous” pre-mixed state, as discussed above, in a sheet-molded compound that can be the consistency of a fibrous putty that can be molded, by the process discussed above, to the desired thickness, typically without the necessity of sanding or machining to obtain the desired thickness.

The resulting solder pallets are used for supporting the soldering process, such as for wave and/or bath soldering, and can be formed from the process described herein, or a similar process, and having the described, or similar construction.

Furthermore, the invention can provide a plaque with the disclosed composition and/or properties that can be sold to fabricators/designers which can then be used to form a solder pallet or circuit board carrier as desired by the fabricators/designers. The initial material will be molded in, for example, 25″×25″ square plaques by various thicknesses, as described above. The described plaque may also be utilized for other purposes, especially those where the desired properties, such as the glass transition temperature, are needed.

Fabricators can use a Computer Numeric Control (CNC) machine to modify the plaque to be used as a selective solder pallet and/or tooling used in “reflow” and surface mount technology. This forms the actual solder pallet to conform to the printed circuit board design utilized by a particular application. The resulting solder pallet can be used in a wave soldering process to selectively affix solder to specified areas of a circuit board having electronic components.

Some significant potential benefits include higher temperature performance (270 degrees C. Tg vs. competitors at ˜170-190 degrees C.), ease of machining, long-term wear and durability under a combination of high temperature exposure and aggressive chemicals. In addition, there is no glass exposure due to wear, which is a major problem with competitive materials. Furthermore, the product is molded to the desired thickness/flatness spec avoiding any need to sand or grind down the plaque to the desired thickness/flatness specification.

The resulting plaque can thus be adapted for use as a solder pallet or other device that is a high temperature, fiber-reinforced, phenolic molding compound-single stage, comprising epoxy laminates that are compression molded into 25″×25″ plaques that will typically run 3 mm-12 mm thick, with 6 mm probably being the most popular. At least two grades can be provided, standard and ESD safe (having a resistivity of about 10̂-5 thru 10̂-9 ohms/cm). Colors include black along with others. The resulting plaques of at least one embodiment show excellent machinability, chemical resistance, and excellent appearance, with a flex strength of about 25 ksi, an HDT >570 degrees F., Tg ˜290 C., warp of about +/−0.015″, and a thickness tolerance of about +/−0.005″, for example. The result can also resist the negative impacts of Adipic Acid (dicarboxylic acid), often resulting from modern soldering processes.

The invention has been described hereinabove using specific examples and embodiments; however, it will be understood by those skilled in the art that various alternatives may be used and equivalents may be substituted for elements and/or steps described herein, without deviating from the scope of the invention. Modifications may be necessary to adapt the invention to a particular situation or to particular needs without departing from the scope of the invention. It is intended that the invention not be limited to the particular implementations and embodiments described herein, but that the claims be given their broadest interpretation to cover all embodiments, literal or equivalent, disclosed or not, covered thereby

What is claimed is:

1. A flat plaque for use in a soldering process, said plaque comprising:
a binding material; and
a re-enforcing fiber distributed throughout said plaque, wherein
said composition has been formed into said flat plaque at a desired thickness without sanding or grinding a surface of said plaque.

2. The plaque of claim 1, wherein said plaque has a glass transition temperature of more than 190 degrees Celsius.

3. The plaque of claim 2, wherein said glass transition temperature is about 270 degrees Celsius or more.

4. The plaque of claim 1, further comprising one or more metallo-silicates.

5. The plaque of claim 1, further comprising a conducting or semi-conducting material also distributed throughout said plaque, wherein said plaque is at least semi-conducting for discharging static electricity.

6. A solder pallet for use in a soldering process, said solder pallet comprising:
at least a portion of said plaque of claim 5, and
means for holding a circuit board on said solder pallet.

7. The plaque of claim 1, wherein said desired thickness is of a substantially constant thickness chosen to be between about 3 mm to about 12 mm.

8. The plaque of claim 1, further comprising reinforcing particles different from said re-enforcing fibers distributed throughout said plaque.

9. The plaque of claim 8, wherein said reinforcing particles comprise phenolic-coated butyl rubber nano-particles.

10. A solder pallet comprising:
at least a portion of said plaque of claim 8, and
means for holding a circuit board on said solder pallet.

11. The plaque of claim 1, where said binding material comprises a thermoset phenolic resin.

12. The plaque of claim 1, wherein said binding material comprises a vinyl ester.

13. A plaque for use in making a solder pallet, said plaque comprising:
a binding material including a vinyl ester;
a glass re-enforcing fiber distributed throughout said plaque; and
a conducting or semi-conducting material distributed throughout said plaque, wherein
said plaque has a glass transition temperature of more than 190 degrees Celsius; and wherein
said plaque is at least semi-conducting for discharging static electricity that may be present during use of said solder pallet.

14. The plaque of claim 13, wherein said plaque is of a substantially constant thickness chosen to be between about 3 mm to about 12 mm.

15. A solder pallet comprising:
at least a portion of said plaque of claim 13, and
means for holding a circuit board on said solder pallet.

16. The plaque of claim 13, further comprising an internal lubricant.

17. A solder pallet comprising:
at least a portion of said plaque of claim 13 having at least one hole formed therethrough, and
means for holding a circuit board on said solder pallet, wherein
said at least one hole is adapted for providing contact between said circuit board or a component mounted on the circuit board and molten solder.

18. A solder pallet comprising:
a plaque including:
a binding material including a vinyl ester;
a glass re-enforcing fiber distributed throughout said plaque and bound together by said binding material also distributed throughout said plaque; and
a conducting or semi-conducting material distributed throughout said plaque, wherein
said plaque has a glass transition temperature of more than 190 degrees Celsius; and wherein
said plaque is at least semi-conducting for discharging static electricity that may be present during use of said solder pallet; and
a plurality of holding devices and/or holes adapted for holding a circuit board in place.

19. A method of manufacturing a plaque for use in a soldering process, said method comprising the steps of:
providing a composition including a binding material and a plurality of re-enforcing fibers;
molding said plaque in a mold by providing one or both of heat and pressure to said composition to form a solid plaque of a desired thickness, wherein
said binding material is distributed throughout said composition prior to said molding step.

20. The method of claim 19, wherein said plaque is molded to a substantially constant thickness chosen to be between about 3 mm to about 12 mm.

21. The method of claim 19, wherein said plaque has a glass transition temperature of more than 190 degrees Celsius.

22. The method of claim 19, wherein said glass transition temperature is about 270 degrees Celsius or more

23. The method of claim 19, wherein said providing said composition further comprises the steps of:
mixing said binding material and said re-enforcing fibers together to form a precursor composition having a consistency of a putty; and
forming a portion of said precursor composition into one or more preforms.

24. The method of claim 19, further comprising the step of forming said plaque into at least one solder pallet.

25. The method of claim 19, further comprising the step of transferring said plaque to a flatness device for cooling said plaque at an elevated temperature to maintain a flatness of said plaque.

26. The method of claim 25, further comprising the step of forming said plaque into at least one solder pallet.

27. The method of claim 26, further comprising the step of transferring said plaque to a flatness device for cooling said plaque at an elevated temperature to maintain a flatness of said plaque.

28. The method of claim 19, further comprising the step of transferring said plaque to a flatness device for cooling said plaque at an elevated temperature to maintain a flatness of said plaque.

29. A method of manufacturing a plaque for use in a soldering process, said method comprising the steps of:
providing a precursor composition including the steps of:
providing a vinyl ester,
providing re-enforcing fibers, and
forming said vinyl ester and reinforcing fibers into said precursor composition into a monolithic uniform product;
forming one or more preforms by putting a portion of said precursor composition under pressure to form said preforms;
molding said one or more preforms in a mold by providing one or both of heat and pressure to said one or more preforms to form a molded plaque; and
maintaining a flatness of said plaque by cooling said molded plaque against smooth surfaces at an elevated temperature, thereby forming said plaque.

30. The method of claim 29, wherein said step of providing a precursor composition further includes the step of providing a conducting or semi-conducting material to be included in said forming step so that said plaque can discharge static electricity.

31. The method of claim 30, further comprising the step of forming said plaque into a solder pallet, said forming including the steps of:
providing a means of holding a circuit board to said solder pallet; and
forming at least one hole in said solder pallet for providing access of at least a portion said circuit board to a solder bath during use of said solder pallet in a soldering process, wherein
said plaque is formed into said solder pallet without sanding or grinding a surface of said plaque.

32. The method of claim 31, said precursor composition further comprising reinforcing particles different from said re-enforcing fibers.

33. The method of claim 32, wherein said reinforcing particles comprise substantially spherical phenolic-coated butyl rubber nano-particles distributed throughout said plaque.

34. The method of claim 29, further comprising the step of forming said plaque into a solder pallet, said forming including the steps of:
providing a means of holding a circuit board to said solder pallet; and
forming at least one hole in said solder pallet for providing access of at least a portion said circuit board to a solder bath during use of said solder pallet in a soldering process, wherein
said plaque is formed into said solder pallet for use without sanding or grinding a surface of said plaque.
